(19) United States
(12) Patent Application Publication
(10) Pub. No.: US 2002/0170059 A1
(43) Pub. Date: Nov. 14, 2002

(54) Universal STB architectures and control methods

(76) Inventor: Khoi Nhu Hoang, Pleasanton, CA (US)

Correspondence Address: PERKINS COIE LLP, P.O. BOX 2168, MENLO PARK, CA, 94026, US

(21) Appl. No.: 10/179,961

(22) Filed: Jun. 24, 2002

Related U.S. Application Data
(62) Division of application No. 09/870,879, filed on May 30, 2001.
Application No. 09/870,879 is a continuation-in-part of application No. 09/584,832, filed on May 31, 2000.
Application No. 09/870,879 is a continuation-in-part of application No. 09/709,948, filed on Nov. 10, 2000.
Application No. 09/870,879 is a continuation-in-part of application No. 09/841,792, filed on Apr. 24, 2001.

(51) Int. Cl. G06F 3/00; H04N 5/445; G06F 13/00

(52) U.S. Cl. 725/54

(57) ABSTRACT

The present invention teaches methods and systems for providing full digital services in a non client specific manner such as VOD, digital broadcast, as well as a universal set-top-box (STB) capable of handling this variety of digital services. A plurality of hardware architectures and complimentary data transmission methods identifying the distinct services through an electronic program guide enable such transmission. The universal STB of the present invention is capable of distinguishing the different services based upon information received in the electronic program guide, and is capable of processing non client specific data. The present invention further provides viewing options such as multiple broadcasts and virtual VCR time-shifting features including pausing, recording, and freeze framing a broadcast. Still further, this variety of digital services can be provided via a uni-directional communication link.

### RELATED APPLICATIONS

This application is a divisional of U. S. application Ser. No. 09/870,879 filed on May 30, 2001 by Khoi Nhu Hoang, which is a continuation-in-part claiming priority to Khoi Ngu Hoang's patent application entitled SYSTEMS AND METHOD FOR PROVIDING VIDEO ON DEMAND SERVICES FOR BROADCASTING SYSTEMS filed on May 31, 2000, bearing application Ser. No. 09/584,832, METHODS FOR PROVIDING VIDEO ON DEMAND FILED Nov. 10, 2000, bearing application Ser. No. 09/709,948 and UNIVERSAL BROADCAST SYSTEM AND METHODS filed on Apr. 24, 2001, bearing application Ser. No. 09/841,792, all four being incorporated herein by reference.

### BRIEF DESCRIPTION OF THE INVENTION

The present invention relates to data-on-demand (DOD) and digital broadcast technology. In particular, the present invention teaches a universal set-top-box (STB) operable to process non client specific digital data including on-demand data and a plurality of mthods for controlling the universal STB.

### BACKGROUND OF THE INVENTION

A variety of mechanisms are available for encoding and transmitting digital data. For example, the International Organization for Standardization (hereinafter referred to as “the ISO/IEC”) has produced a standard (MPEG-2) for the coding of moving pictures and associated audio. Due to the ubiquity of MPEG-2 and its relevance to the present invention, some preliminary discussion is useful.

The ISO/IEC MPEG-2 standard is set forth in four documents. The document ISO/IEC 13818-1 (systems) specifies the system coding. It defines a multiplexed structure for combining audio and video data and means of representing the timing information needed to replay synchronized sequences in real-time. The document ISO/IEC 13818-2 (video) specifies the coded representation of video data and the decoding process required to reconstruct pictures. The document ISO/IEC 13818-3 (audio) specifies the coded representation of audio data and the decoding process required to reconstruct the audio data. Lastly, the document ISO/IEC 13818-4 (conformance) specifies procedures for determining the characteristics of coded bitstreams and for testing compliance with the requirements set forth in the ISO/IEC documents 13818-1, 13818-2, and 13818-3. These four documents (collectively “the MPEG-2 standard”) are incorporated herein by reference.

In the context of digital broadcast systems, a bit stream, multiplexed in accordance with the MPEG-2 standard, is a “transport stream” constructed from “packetized elementary stream” (or PES) packets and packets containing other necessary information. A “packetized elementary stream” (or PES) packet is a data structure used to carry “elementary stream data.” An “elementary stream” is a generic term for one of (a) coded video, (b) coded audio, or (c) other coded bit streams carried in a sequence of PES packets with one stream ID. Transport streams support multiplexing of video and audio compressed streams from one program with a common time base.

PRIOR ART FIG. 1 illustrates the packetizing of compressed video data 106 of a video sequence 102 into a stream of PES packets 108, and then, into a stream of transport stream packets 112. Specifically, a video sequence 102 includes various headers 104 and associated compressed video data 106. The video sequence 102 is parsed into variable length segments, each having an associated PES packet header 110 to form a PES packet stream 108. The PES packet stream 108 is then parsed into segments, each of which is provided with a transport stream header 114 to form a transport stream 112. Each transport stream packet of the transport stream 112 is 188 bytes in length.

Transport streams permit one or more programs with one or more independent time bases to be combined into a single stream. Transport streams are useful in instances where data storage and/or transport means are noisy. The rate of transport streams, and their constituent packetized elementary streams (PESs) may be fixed or variable. This rate is defined by values and locations of program clock reference (or PCR) fields within the transport stream.

A PES packet, as defined in the MPEG-2 standard, includes a PES packet header comprising a 24 bit start code prefix field, an eight (8) bit stream identifier field, a sixteen (16) bit PES packet length field, an optional PES header, and the payload or data section 706. Each of these fields is described in the MPEG-2 standard.

The MPEG-2 standard focuses on the encoding and transport of video and audio data. In general, the MPEG-2 standard uses compression algorithms such that video and audio data may be more efficiently stored and communicated.

PRIOR ART FIG. 2 is a block schematic showing a digital broadcast system 200 including a digital broadcast server 202 and a set-top-box 204 suitable for processing digital broadcast data. FIG. 2 illustrates not only the components of the system but also the process flow of encoding, communicating (from the digital broadcast server 202 to the set-top-box 204), and decoding video and audio data in accordance with the MPEG-2 standard. As can be seen, in the typical prior art broadcast method, the MPEG-2 transport stream is used in a streaming manner.

At the digital broadcast server 202, video data is provided to a video encoder 206 which encodes the video data in accordance with the MPEG-2 standard (specified in the document ISO/IEC 13818-2). The video encoder 206 provides encoded video 208 to a packetizer 210 which packetizes the encoded video 208. The packetized encoded video 212 provided by the packetizer 210 is then provided to a transport stream multiplexer 214.

Similarly, at the digital broadcast server 202, audio data is provided to an audio encoder 214 which encodes the audio data in accordance with the MPEG-2 standard (specified in the document ISO/IEC 13818-3). The audio encoder 214 provides encoded audio 218 to a packetizer 220 which packetizes the encoded audio 218. The packetized encoded audio 222 provided by the packetizer 220 is then provided to the transport stream multiplexer 214.

The transport stream multiplexer 214 multiplexes the encoded audio and video packets and transmits the resulting multiplexed stream to a set-top-box 204 via distribution infrastructure 224. This distribution infrastructure 224 may be, for example, a telephone network and/or a cable TV (CATV) system, employing optical fiber and implementing asynchronous transfer mode (ATM) transmission protocols. At the set-top-box 204, on a remote end of the distribution infrastructure 224, a transport stream demultiplexer 230 receives the multiplexed transport stream. Based on the packet identification number of a particular packet, the transport stream demultiplexer 230 separates the encoded audio and video packets and provides the video packets to a video decoder 232 via link 238 and the audio packets to an audio decoder 236 via link 240.

The transport stream demultiplexer 230 also provides timing information to a clock control unit 236. The clock control unit 236 provides timing outputs to the both the video decoder 232 and the audio decoder 236 based on the timing information provided by the transport stream demultiplexer 230 (e.g., based on the values of PCR fields). The video decoder 232 provides video data which corresponds to the video data originally provided to the video encoder 206. Similarly, the audio decoder 236 provides audio data which corresponds to the audio data originally provided to the audio encoder 216.

PRIOR ART FIG. 3 shows a simplified functional block diagram of a VOD system 300. At the heart of the VOD system 300 is the video server 310 which routes the digital movies, resident in the movie storage system 312, to the distribution infrastructure 314. This distribution infrastructure 314 may be, for example, a telephone network and/or a cable TV (CATV) system, employing optical fiber and implementing asynchronous transfer mode (ATM) transmission protocols. The distribution infrastructure 314 delivers movies to individual homes based on the routing information supplied by the video server 310.

The VOD system 300 also includes a plurality of VOD STBs 304 suitable for processing VOD in the VOD system 300. Each STB 304 receives and decodes a digital movie and converts it to a signal for display on a TV set or monitor. As will be appreciated, the prior art STB 304 utilizes a streaming data architecture much like the STB 204 described above with reference to FIG. 2. In addition, the distribution infrastructure 314 includes a “back channel” through which a viewer orders and controls the playing of the digital movies. The back channel is often a telephone line or such separate from the primary transmission medium, or may be upstream in a two-way cable system. The back channel routes commands from the VOD STB 304 back to the video server 310 via the distribution network 314. The primary function of the video server 310 is to route compressed digital video streams from their storage location to the requesting viewers.

As seen from the above-description, the typical client STB in a digital broadcast or DOD system utilizes a “hardwired” streaming data type architecture. This architecture is workable for prior art applications wherein digital data received is delivered in a known-time slot and sequence, e.g. digital broadcast, or in a client specific VOD format, as the STB can be designed for the specific application. However, the hardwired architecture of prior art STBs provides no flexibility for accessing received data and performing more sophisticated operations therewith. Additionally, client specific VOD type systems use large amounts of bandwidth directly proportional to the number of clients.

The typical model for digital broadcast and DOD systems described above adheres to what is termed a “bi-directional client-server model.” In order to point out defects inherent to this prior art system, the typical hardware architecture generic to such a DOD system will be described below with reference to FIG. 4. Further, a pair of methods for controlling the prior art DOD server and the prior art DOD client will be described below with reference to FIG. 5 and FIG. 6, respectively.

PRIOR ART FIG. 4 illustrates a general diagram of a DOD system 320 having a bi-directional client-server architecture. The DOD system 322 includes a DOD server 322 bi-directionally coupled with a plurality of DOD clients 324 vi a communication link 326. As will be appreciated, the VOD system 300 of FIG. 3 is a somewhat specific example of the DOD system 320.

Broadly speaking, the DOD system 320 operation adheres to the well known client-server model as follows. In some manner, typically through transmission of an Electronic Program Guide (EPG) by the DOD server 322, the clients 324 are informed of available on-demand data. Using the EPG for reference, a requesting DOD client 324 requests specific data from the DOD server 322 via the communication link 326. The DOD server 322 interprets the client request, and then prepares the client specific data in a format suitable for use by the requesting client 324.

Once the client specific data is prepared, the server 322 transmits the client specific data to the requesting client 324. The requesting client 324 receives, via a specifically allocated portion of the communication link 326, the requested client specific data in a readably usable format. The requested client specific data is provided in a format ready for presentation by the DOD client to the end user. These client-server processes are described below in more detail with reference to FIGS. 5-6.

Under the client-server model of FIG. 4, the available bandwidth of communication link 326 must be divided up into allocated portions 328, each allocated portion being dedicated to a particular client. Hence the bandwidth required for prior art DOD systems is directly proportional to the number of clients being served.

Although communication link 326 may be a true bi-directional communications medium, such infrastructure is uncommon. Instead, typical implementations today cobble together existing infrastructure such as fiber optic cabling and telephone lines to implement the necessary bi-directional communications. For example, the fiber optic cable may be used for server transmission of client specific data while an existing telephone line may be used for client transmission of requests.

Turning next to PRIOR ART FIG. 5, a DOD server method 340 in accordance with the prior art will now be described. In a first step 342, the DOD server allocates the available transmission bandwidth to the DOD clients. The allocation is required as each DOD client of the prior art DOD system anticipates receipt of client specific on-demand data, such client not being able to process more data in a more sophisticated format. Hence a dedicated portion of the bandwidth must be set aside for each active client.

With further reference to FIG. 5, in a next step 344 the DOD server prepares and transmits a suitable EPG to each client. It will be appreciated that different EPGs may be transmitted for different clients depending upon factors such as subscription levels, available services, personalized settings, payment history, etc. In any event, in a next step 346, the DOD server receives a demand for specific data from a specific client. Then in a step 348, the DOD server prepares the requested client specific data for transmission in a format suitable for the requesting client. This format is typically a streaming data format. Step 348 may include such actions as retrieving the client specific data from a persistent storage mechanism and preparing an appropriate channel server for data transmission.

Continuing with a step 350, the DOD server transmits the client specific data via the bandwidth allocated to the requesting client. In a looping step 352, the receive demand step 346, the prepare client specific data step 348, and the transmit client specific data step 350 are repeated as client requests for specific data are received.

Turning next to FIG. 6, a client method 360 for retrieving on-demand data will now be described. In a tuning step 362, the DOD client will tune into the appropriate channel program and in a receiving step 364 the DOD client will receive the EPG transmitted by the DOD server. In a next step 366, the DOD client provides the EPG information to a DOD user and in a step 368, receives a request for specific data from the DOD user. Then in a step 370, the DOD client demands that the DOD server provide the requested client specific data. In a step 372, in anticipation of the requested client specific data, the DOD client tunes into the allocated bandwidth. Then in a step 374, the DOD client receives via allocated bandwidth the requested client specific data in a readably usable format and provides it to the DOD user.

As the above discussion reflects, prior art DOD systems are bandwidth and processing intensive in that bandwidth and processing power requirements are proportional to the number of clients being served. Additionally, on-demand data must be provided in a client specific manner, leaving little flexibility for sophisticated data processing. The data processing flexibility of the prior art is further limited by the hardwired client architecture. Still further, prior art VOD systems require a bi-directional communication link in order to operate, thus taxing and making awkward existing infrastructure. No prior digital data method provide a paradigm encompassing both VOD and digital broadcast within a single system.

Therefore, it is desirable to provide a DOD system operable over existing uni-directional communications links in a manner where bandwidth and processing power are not client dependent. This client independent system would provide even greater benefit when used in a bi-directional context. Furthermore, it is desirable to provide a digital broadcast system that is capable of providing simultaneous digital broadcast and on-demand services to a large number of clients over virtually any transmission medium without replacing existing communication infrastructure. What is also needed is a way to provide viewing options for viewers such as multiple broadcasts and virtual VCR time-shifting features such as pausing, recording, and freeze framing a broadcast. It is further desirable to provide this functionality via a uni-directional communication link.

### SUMMARY OF THE INVENTION

The present invention teaches methods and systems for providing full digital services such as VOD, digital broadcast, and time shifting from any broadcasting medium. These include a universal digital data system, a universal STB, and a variety of methods for handling these digital services and controlling the universal STB.

A first embodiment of the present invention teaches a universal STB capable of receiving and handling a plurality of digital services such as VOD and digital broadcast. This embodiment teaches universal STB having a highly flexible architecture capable of sophisticated processing of received data. This architecture includes a databus, a first communication device suitable for coupling to a digital broadcast communications medium, a memory typically including persistent and transient memory bi-directionally coupled to the databus, a digital data decoder bi-directionally coupled to the databus, and a central processing unit (CPU) bi-directionally coupled to the databus.

The CPU of the first embodiment of the present invention implements a STB control process for controlling the memory, the digital decoder, and the demodulator. The STB control process is operable to process digital data such as that received at the first communications device.

The STB control process should be capable of determining the nature of data received in a plurality of channels, e.g., through information provided in an EPG. Still further, the STB can provide EPG data to a user, and receive and implement instructions from the user of the universal STB. The STB control process is further operable to tune the STB to a first channel in order to select user requested data, determine the nature of the selected data, decode the selected data, decompress the selected data, reassemble the decoded data, store the selected data to memory, and provide the selected data in a properly processed manner to an output device. In preferred embodiments, the STB control process is operable to simultaneously tune into two or more of the plurality of channels, and to simultaneously process data from two or more of the plurality of channels.

The CPU may further implement a user interface driver suitable for interpreting commands received from a user interface coupled to the databus. The user interface may be any suitable interface such as a remote control device, a keyboard, or a separate computer system.

Another embodiment of the present invention teaches a universal digital data system providing full digital services over a plurality of channels via a uni-directional communications link. The universal digital data system includes a broadcast medium, a universal broadcast system bi-directionally or uni-directionally coupled to the broadcast medium, and a universal STB uni-directionally coupled to the broadcast medium. The universal broadcast system includes digital broadcast circuitry for a first digital broadcast channel, data-on-demand circuitry for a second channel, and broadcast circuitry operable to transmit via the broadcast medium an EPG and other data over the first channel and the second channel.

One aspect of the present invention teaches a computer implemented method for controlling a universal STB. This method teaches receiving digital data in a plurality of channels and an electronic program guide (EPG) indicating the nature of data transmitted in each of the plurality of channels, providing the EPG data to a user of the universal STB, receiving data processing instructions from the user of the universal STB, and implementing the instructions from the user of the universal STB.

In preferred embodiments of the present invention, this method is capable of responding to an instruction received from the user of the universal STB to select data from a first channel for display and to select data from a second channel for recording. To accomplish this, the method teaches tuning into the first channel and processing for display the selected data from the first channel and concurrently tuning into the second channel and processing for storage the selected data from the second channel.

### BRIEF DESCRIPTION OF THE DRAWINGS

PRIOR ART FIG. 1 illustrates pictorially the packetizing of compressed video data into a stream of packets and a stream of transport packets.

PRIOR ART FIG. 2 illustrates by block diagram a system according to the MPEG-2 standard.

PRIOR ART FIG. 3 illustrates a simplified functional block diagram of a VOD system.

PRIOR ART FIG. 4 illustrates a DOD system adhering to a prior art bi-directional client-server architecture.

PRIOR ART FIG. 5 illustrates a DOD server method for providing DOD via a bi-directional, client specific data transmission mechanism.

PRIOR ART FIG. 6 illustrates a DOD client method for receiving and processing client specific data via a bi-directional transmission mechanism.

FIG. 7 is a block diagram of a digital broadcast server in accordance with one embodiment of the present invention.

FIG. 8 is a block diagram of a VOD server in accordance with yet another embodiment of the present invention.

FIG. 9 is a block diagram of a universal digital data server in accordance with another embodiment of the present invention.

FIG. 10 is a block diagram of a channel server suitable for use in transmitting VOD data in accordance with one embodiment of the present invention.

FIG. 11 is a block diagram showing the hardware architecture of a universal STB in accordance with yet another embodiment of the present invention.

FIG. 12 is a flow chart illustrating a computer implemented method for controlling a universal broadcast system of the present invention.

FIG. 13 is a flow chart illustrating a computer implemented method for off-line preparation of a channel server for transmission of non client specific on-demand data.

FIG. 14 is a flow chart illustrating a computer implemented method for controlling a universal STB of the present invention.

FIG. 15 is a flow chart illustrating a computer implemented universal broadcast method in accordance with another embodiment of the present invention.

FIG. 16 is a flow chart illustrating a computer implemented method for preparing data off line for broadcast of non client specific data.

FIG. 17 is a flow chart illustrating a computer implemented method for receiving and processing a variety of digital data including non client specific on-demand data.

FIG. 18 is a flow chart illustrating a computer implemented method generating a constant bandwidth scheduling matrix for delivery of non client specific on demand data in accordance with a further embodiment of the present invention.

### DETAILED DESCRIPTION OF THE INVENTION

In the following detailed description of the embodiments, reference is made to the drawings that accompany and that are a part of the embodiments. The drawings show, by way of illustration, specific embodiments in which the invention may be practiced. Those embodiments are described in sufficient detail to enable those skilled in the art to practice the invention and it is to be understood that other embodiments may be utilized and that structural, logical, and electrical changes as well as other modifications may be made without departing from the spirit and scope of the present invention.

The present invention teaches methods and systems for providing full digital services such as VOD and digital broadcast, and a universal set-top-box (STB) capable of handling this variety of digital services. The universal STB of the present invention is capable of distinguishing the different services based upon information received in the electronic program guide, and is designed with a unique hardware architecture including a large buffer.

In addition, the universal STB of the present invention is capable of processing non client specific on-demand data and providing user selected on-demand data. This STB capability enables DOD in a uni-directional communication framework without the high bandwidth requirements of prior art DOD systems. The present invention further provides viewing options such as multiple broadcasts and virtual VCR time-shifting features including pausing, recording, and freeze framing a broadcast without suffering the volatility and poor quality of an Internet streaming broadcast. This variety of digital services is provided via a uni-directional communication link. However, those skilled in the art will recognize that all aspects of the present invention can be implemented within the bi-directional communication paradigm, the only difference being that even further features can be provided to the digital broadcast and DOD user when a bi-directional communication link is available.

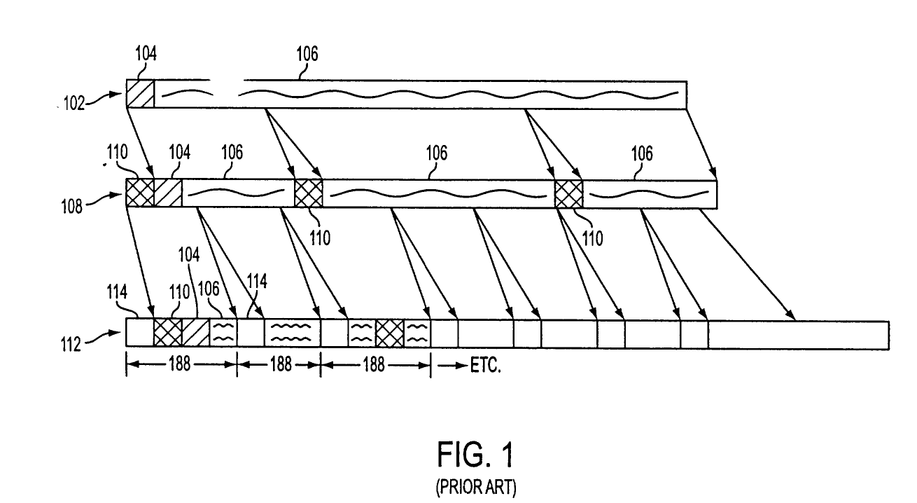

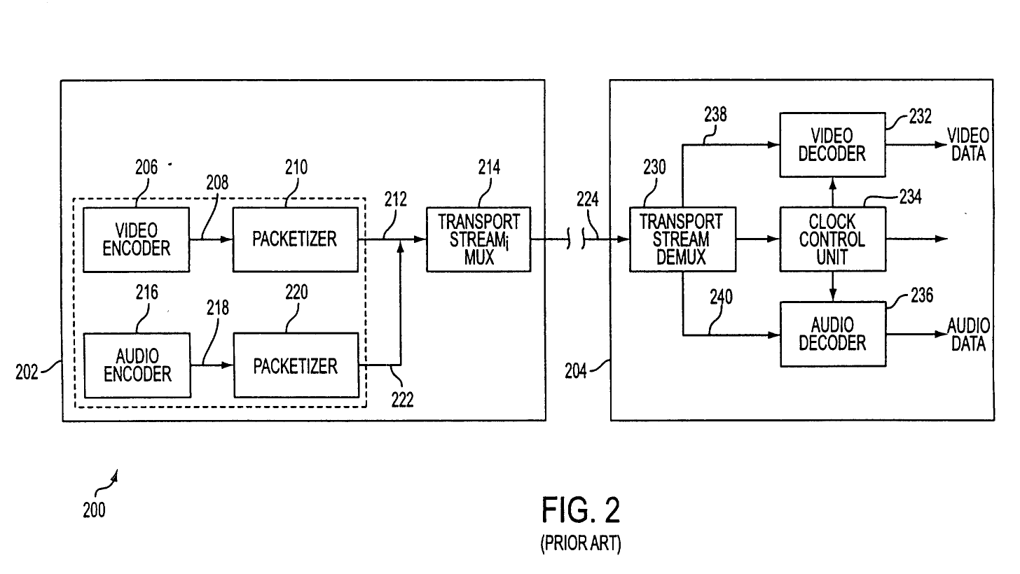

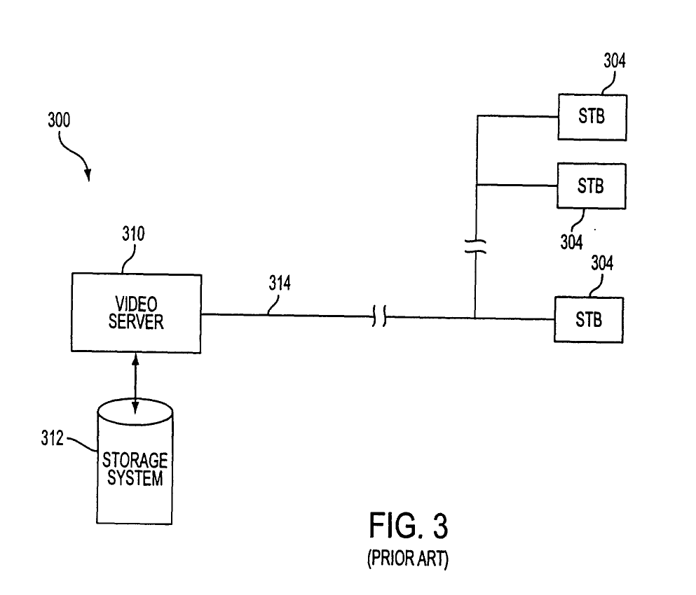

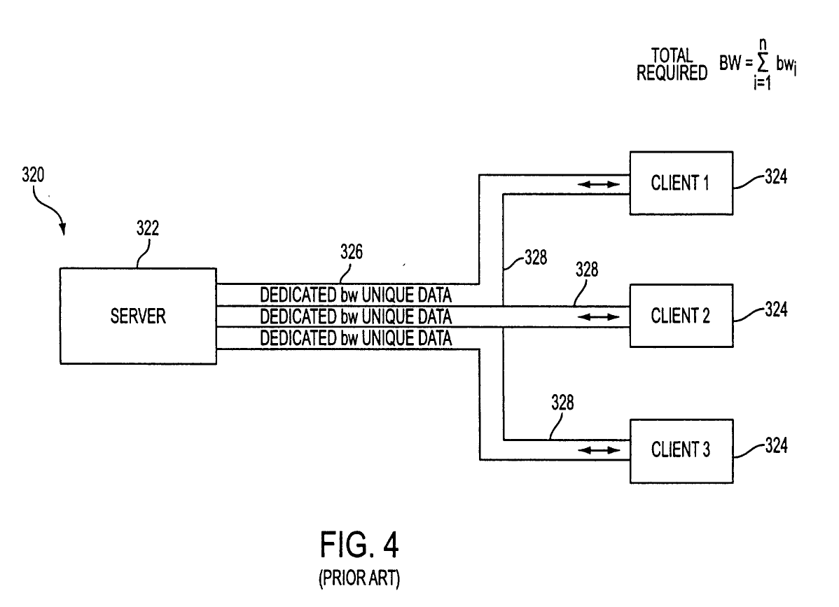

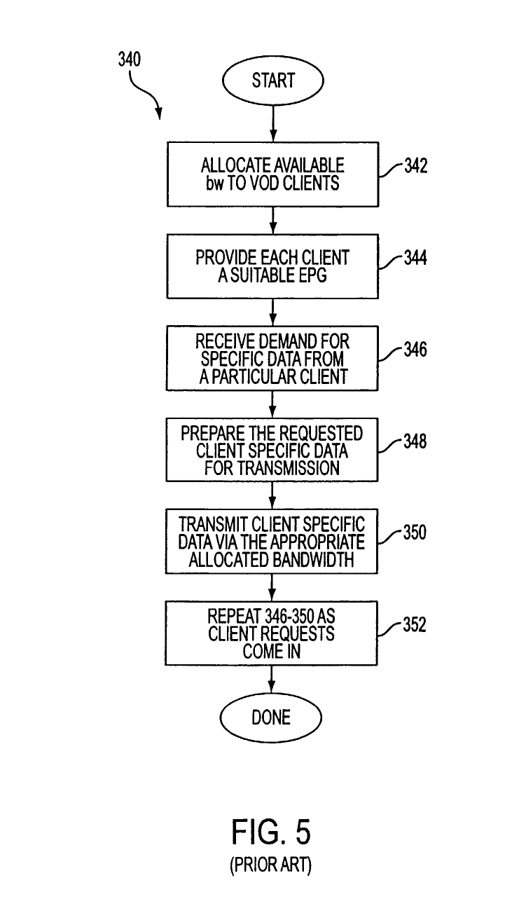

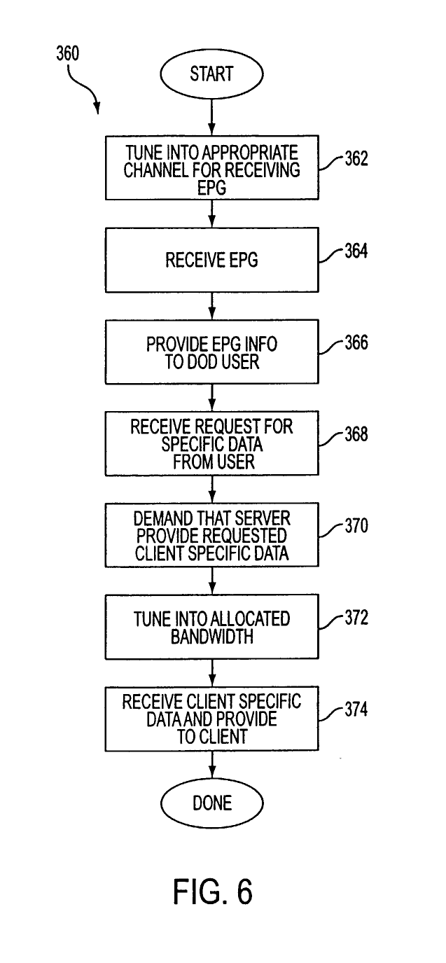

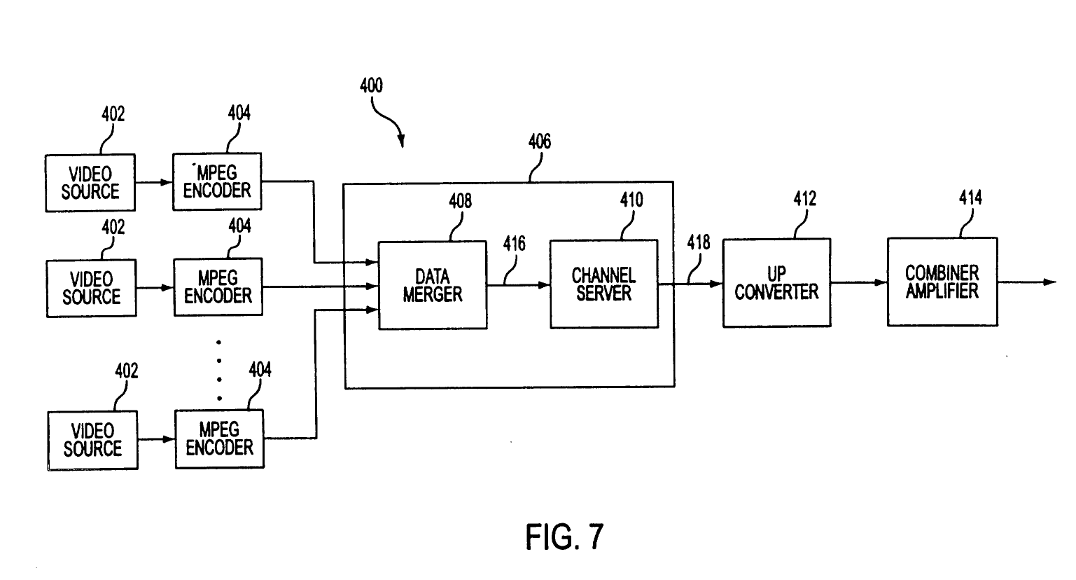

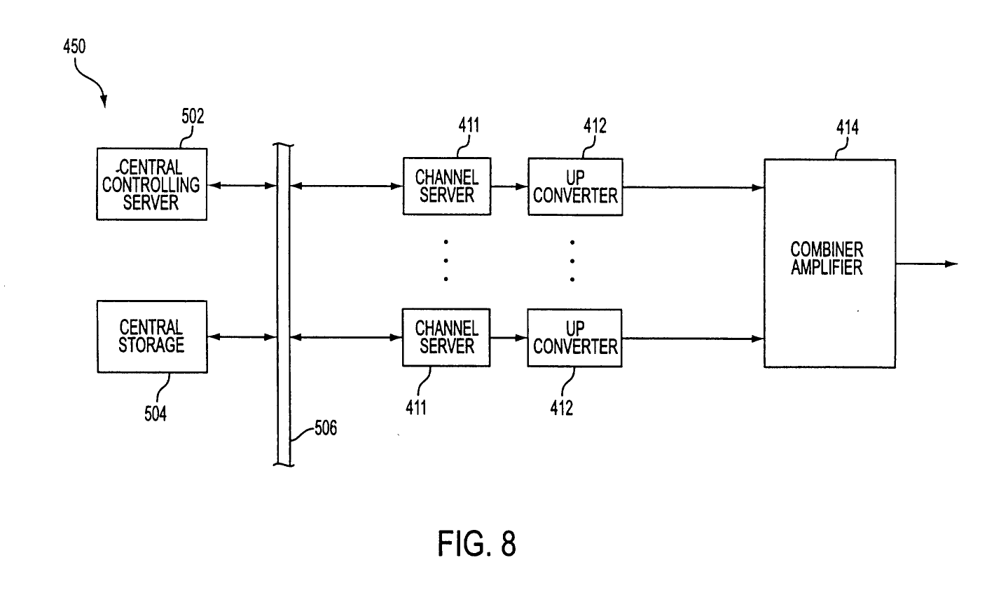

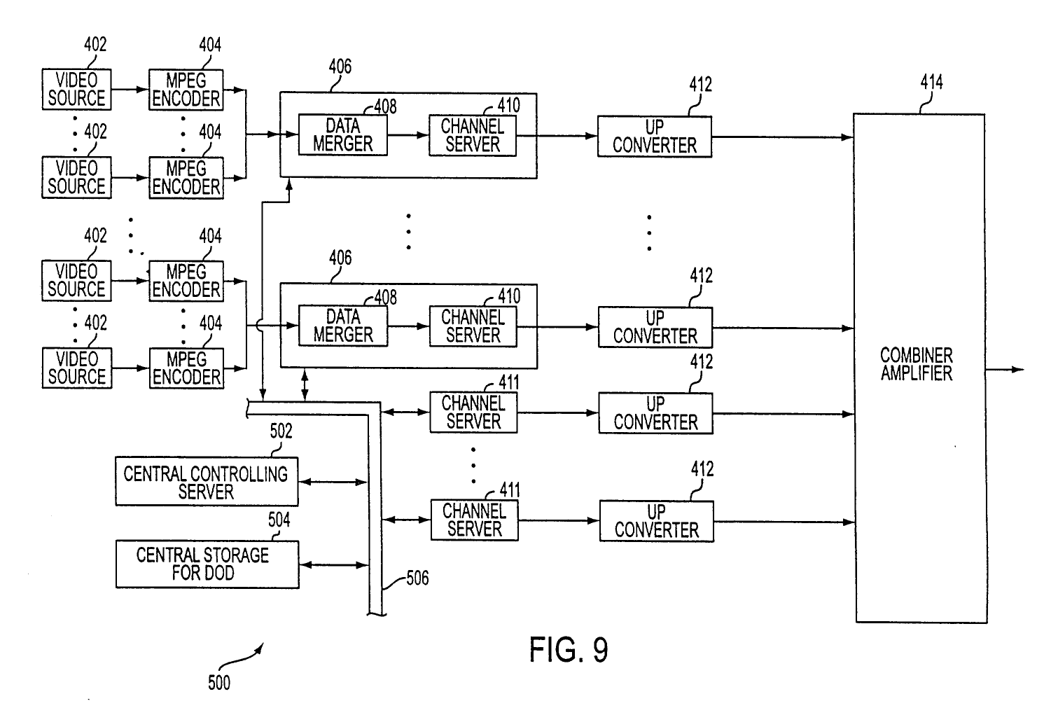

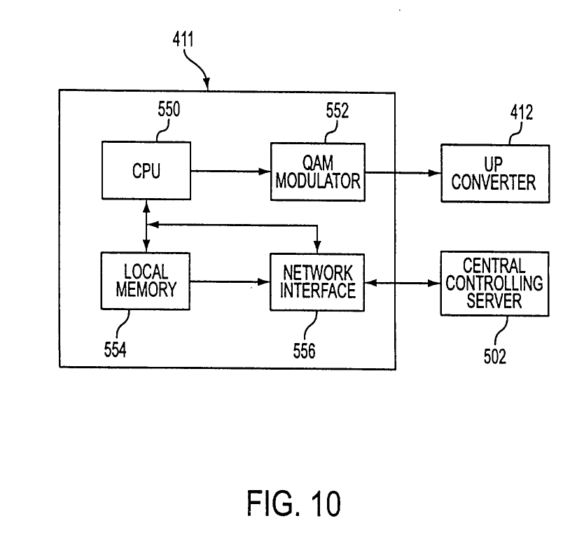

Discussion of the universal broadcast server will begin with FIG. 7 illustrating a digital broadcast server suitable for providing digital broadcast programming in accordance with the present invention. Turning next to FIG. 8, a VOD server in accordance with another embodiment of the present invention will be described. In FIG. 9, a universal broadcast server providing for multiple channels of digital broadcast and VOD will be described. Then with reference to FIG. 10, a channel server suitable for VOD transmission will be described.

Turning directly to FIG. 7, a single channel portion of a digital broadcast server 400 includes a plurality of video sources 402, a plurality of digital data encoders 404, a data merger device 408, a channel server 410, an up converter 412, and a combiner amplifier 414. The video sources 402 may provide analog video data (e.g., from a camera, VCR, TV program) or digital video data (e.g., MPEG file, MPEG transport stream). The digital data encoders 404 are each typically an MPEG encoder/converter hardware device. Those skilled in the art will recognize that other encoding standards are available, and the encoding may be accomplished in software or firmware rather than hardware.

The MPEG program stream output of the digital data encoders 404 is provided to the data merger device 408 for generation of a combined data stream 416. The data merger device 408 can take on any suitable form. For example, the data merger device 408 may be an Ethernet switch if the digital data encoder 404 output and the channel server 410 input are Ethernet compatible. The data merger device 408 may likewise be implemented within a computer system having a suitable interface.

The channel server 410 operates on the combined data stream 416 to generate an output 418 consisting of packets having sub-blocks and blocks. In a preferred embodiment, the block number will be increased sequentially and finally wrap back to zero (0) when the 32-bit, 64-bit wide or larger block number is full (i.e., 2³²-1, 2⁶⁴-1 or 2ⁿ-1). Each packet generated by the channel server 410 will include a corresponding ProgramID. This ProgramID will enable a universal STB to later determine the nature of the received data packet, e.g., digital broadcast data or on-demand data.

In preferred embodiments of the present invention, each data merger device 408 and associated channel server 410 are fabricated within a single device 406. However, these devices may be manufactured as separate devices.

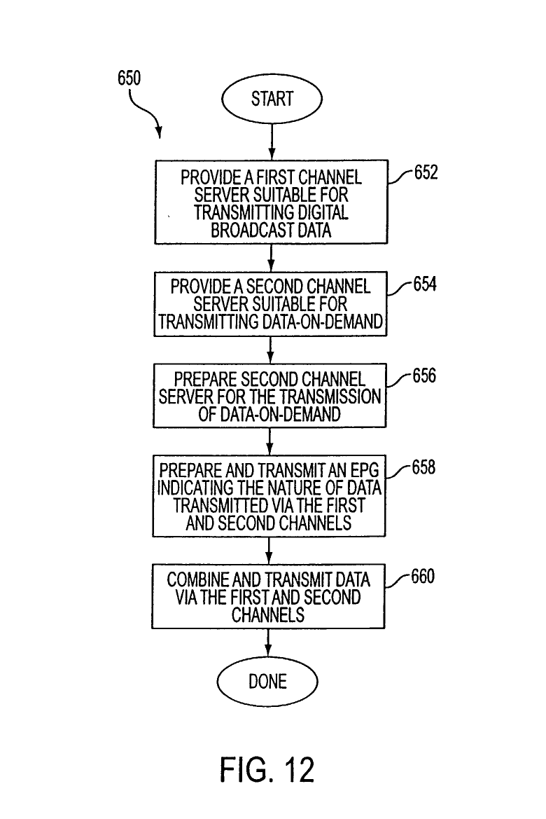

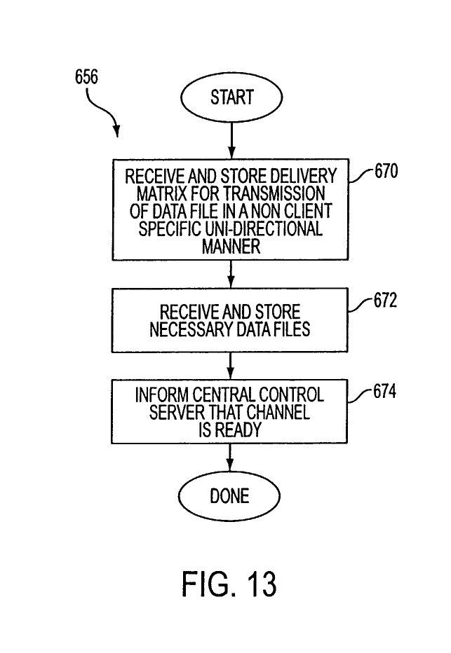

FIG. 8 illustrates the architecture for a VOD server 450 in accordance with one embodiment of the present invention. The VOD server 450 includes a plurality of channel servers 411, a plurality of up converters 412 each corresponding to a channel server 411, a combiner amplifier 414, a central controlling server 502, and a central storage 504, coupled as illustrated through a data bus 506. As will be described almost immediately below and with further reference later to FIGS. 12-13, the central controlling server 502 controls off-line operation of the channel servers 411, as well as initiating real-time transmission once the channel servers 411 are ready. The central storage 504 typically stores data files in a digital format. However, any suitable mass persistent data storage device may be used.

In an exemplary embodiment, data files stored in the central storage 504 are accessible via a standard network interface (e.g., Ethernet connection) by any authorized computer, such as the central controlling server 502, connected to the network. The channel servers 411 provide data files that are retrieved from the central storage 504 in accordance with instructions from the central controlling server 502. The retrieval of digital data and the scheduling of transmission of the digital data for VOD is performed “off-line” to fully prepare each channel server 411 for real-time data transmission. Each channel server 411 informs the central controlling server 502 when ready to provide VOD, at which point the central controlling server 502 can control the channel servers 411 to begin VOD transmission.

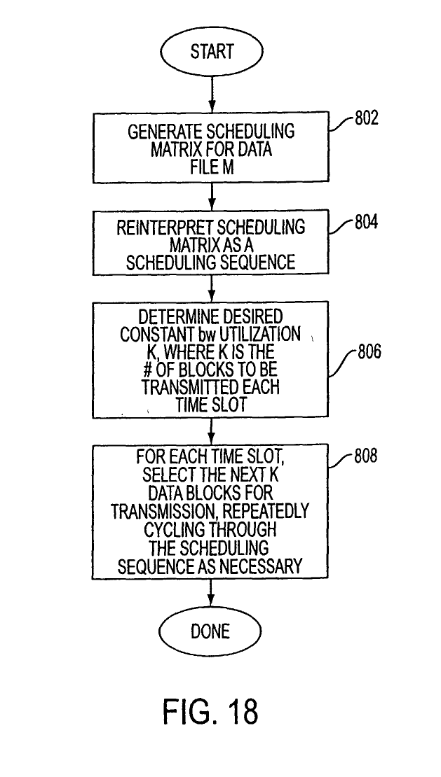

In a preferred embodiment, the central controlling server 502 includes a graphics user interface (not shown) to enable a service provider to schedule data delivery by a drag-and-drop operation. Further, the central controlling server 502 authenticates and controls the channel servers 410 to start or stop according to delivery matrices. Systems and methods for providing uni-directional DOD broadcast matrices are taught in Khoi Hoang's patent application entitled SYSTEMS AND METHODS FOR PROVIDING VIDEO ON DEMAND SERVICES FOR BROADCASTING SYSTEMS filed on May 31, 2000, bearing application Ser. No. 09/584,832, which is incorporated herein by reference. A further improvement upon the Ser. No. 09/584,832 invention is a method for generating a constant bandwidth scheduling matrix as described below with reference to FIG. 18.

Again briefly, the central controlling server 502 automatically selects a channel and calculates delivery matrices for transmitting data files in the selected channel. The central controlling server 502 provides offline addition, deletion, and update of data file information (e.g., duration, category, rating, and/or brief description). Further, the central controlling server 502 controls the central storage 504 by updating data files and databases stored therein.

Each channel server 411 is assigned to a channel and is coupled to an up-converter 412. The output of each channel server 411 is a quadrature amplitude modulation (QAM) modulated intermediate frequency (IF) signal having a suitable frequency for the corresponding up-converter 412. The QAM-modulated IF signals are dependent upon adopted standards. The current adopted standard in the United States is the data-over-cable-systems-interface-specification (DOCSIS) standard, which requires an approximately 43.75 MHz IF frequency. A preferred channel server 411 is described below in more detail with reference to FIG. 10.

The up-converters 412 convert IF signals received from the channel servers 104 to radio frequency signals (RF signals). The RF signals, which include frequency and bandwidth, are dependent on a desired channel and adopted standards. For example, under the current standard in the United States for a cable television channel 80, the RF signal has a frequency of approximately 559.25 MHz and a bandwidth of approximately 6 MHz.

The outputs of the up-converters 412 are applied to the combiner/amplifier 414. The combiner/amplifier 414 amplifies, conditions, and combines the received RF signals then outputs the signals out to a transmission medium.

FIG. 9 illustrates a universal broadcast server 500 in accordance with a preferred embodiment of the invention. The universal broadcast server 500 provides both on-demand and digital data broadcasting in a single broadcast server system. The universal broadcast server 500 includes a plurality of video sources 402, a plurality of digital data encoders 404, a plurality of digital broadcast devices 406 each having a data merger device 408 and a channel server 410, a plurality of channel servers 411, a plurality of up converters 412, a combiner amplifier 414, a central controlling server 502, and a central storage device 504, coupled as illustrated through a data bus 506.

The central controlling server 502 controls data merger devices 408, and the channel servers 410 and 411. The digital broadcast is performed in real-time through merger of streaming program data, while providing the VOD service includes off-line preparation of the channel servers 411. In this way, the universal broadcast system 500 provides full digital services such as VOD and digital broadcast.

FIG. 10 illustrates an exemplary channel server 411 in accordance with an embodiment of the invention. The channel server 411 comprises a CPU 550, a QAM modulator 552, a local memory 554, and a network interface 556. The server controller 602 controls the overall operation of the channel server 411 by instructing the CPU 550 to divide data files into blocks (further into sub-blocks and data packets), in the case of data-on-demand services, selecting data blocks for transmission in accordance with a delivery matrix provided by the central controlling server 502, encode selected data, compress encoded data, then delivers compressed data to the QAM modulator 552.

The QAM modulator 552 receives data to be transmitted via a bus (i.e., PCI, CPU local bus) or Ethernet connections. In an exemplary embodiment, the QAM modulator 552 may include a downstream QAM modulator, an upstream quadrature amplitude modulation/quadrature phase shift keying (QAM/QPSK) burst demodulator with forward error correction decoder, and/or an upstream tuner. The output of the QAM modulator 552 is an IF signal that can be applied directly to an up-converter 412.

The network interface 556 connects the channel server 411 to other channel servers 411 and to the central controlling server 502 to execute the scheduling and controlling instructions from the central controlling server 502, reporting status back to the central controlling server 502, and receiving data files from the central storage 504. Any data file retrieved from the central storage 504 can be stored in the local memory 554 of the channel server 411 before the data file is processed in accordance with instructions from the server controller 502. In an exemplary embodiment, the channel server 411 may send one or more DOD data streams depending on the bandwidth of a cable channel (e.g., 6, 6.5, or 8 MHz), QAM modulation (e.g., QAM 64 or QAM 256), and a compression standard/bit rate of the DOD data stream (e.g., MPEG-1 or MPEG-2).

A number of digital programs can be broadcast in an analog channel depending on the channel bandwidth, the modulation scheme and the required program bit-rate (MPEG). For example, in a 6 MHz CATV channel using QAM64, the channel maximum throughput is 27 Mb/s. If the required bit rate is 4 Mb/s, theoretically 6 digital programs can be sent over one analog channel. The actual number is smaller because of protocol overhead.

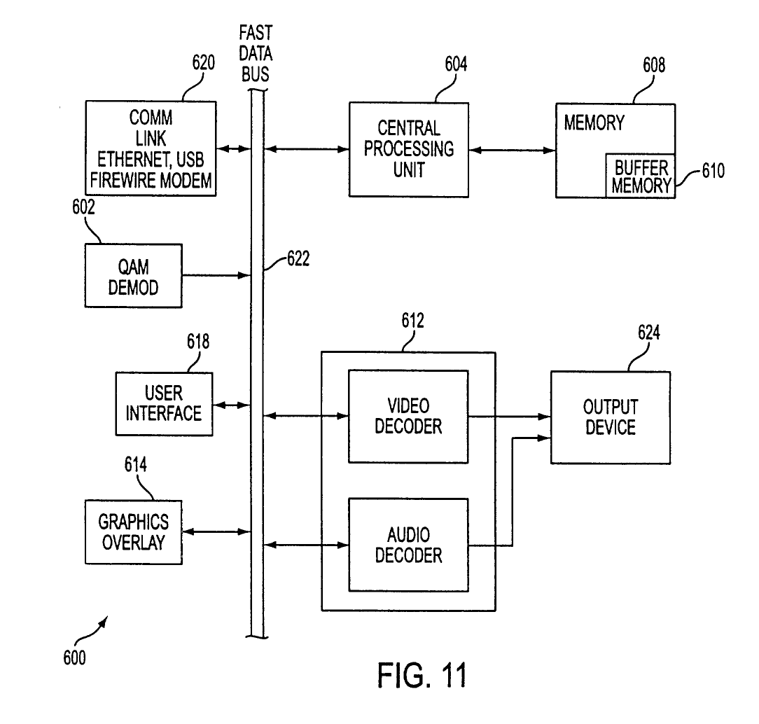

FIG. 11 illustrates a universal STB 600 in accordance with one embodiment of the invention. The STB 600 comprises a QAM demodulator 602, a CPU 604, a local memory 608, a buffer memory 610, a decoder 612 having video and audio decoding capabilities, a graphics overlay module 614, a user interface 618, a communications link 620, and a fast data bus 622 coupling these devices as illustrated. The CPU 602 controls overall operation of the universal STB 600 in order to select data in response to a client's request, decode selected data, decompress decoded data, re-assemble decoded data, store decoded data in the local memory 608 or the buffer memory 610, and deliver stored data to the decoder 612. In an exemplary embodiment, the local memory 608 comprises non-volatile memory (e.g., a hard drive) and the buffer memory 610 comprises volatile memory.

In one embodiment, the QAM demodulator 602 comprises transmitter and receiver modules and one or more of the following: privacy encryption/decryption module, forward error correction decoder/encoder, tuner control, downstream and upstream processors, CPU and memory interface circuits. The QAM demodulator 602 receives modulated IF signals, samples and demodulates the signals to restore data.

In an exemplary embodiment, when access is granted, the decoder 612 decodes at least one data block to transform the data block into images displayable on an output screen. The decoder 612 supports commands from a subscribing client, such as play, stop, pause, step, rewind, forward, etc. The decoder 612 provides decoded data to an output device 624 for use by the client. The output device 624 may be any suitable device such as a television, computer, any appropriate display monitor, a VCR, or the like.

The graphics overlay module 614 enhances displayed graphics quality by, for example, providing alpha blending or picture-in-picture capabilities. In an exemplary embodiment, the graphics overlay module 614 can be used for graphics acceleration during game playing mode, for example, when the service provider provides games-on-demand services using the system in accordance with the invention.

The user interface 618 enables user control of the STB 600, and may be any suitable device such as a remote control device, a keyboard, a smartcard, etc. The communications link 620 provides an additional communications connection. This may be coupled to another computer, or may be used to implement bi-directional communication. The data bus 622 is preferably a commercially available “fast” data bus suitable for performing data communications in a real time manner as required by the present invention. Suitable examples are USB, firewire, etc.

In an exemplary embodiment, although data files are broadcast to all cable television subscribers, only the DOD subscriber who has a compatible STB 600 will be able to decode and enjoy data-on-demand services. In one exemplary embodiment, permission to obtain data files on demand can be obtained via a smart card system in the user interface 618. A smart card may be rechargeable at a local store or vending machine set up by a service provider. In another exemplary embodiment, a flat fee system provides a subscriber unlimited access to all available data files.

In preferred embodiments, data-on-demand interactive features permits a client to select at any time an available data file. The amount of time between when a client presses a select button and the time the selected data file begins playing is referred to as a response time. As more resources are allocated (e.g., bandwidth, server capability) to provide DOD services, the response time gets shorter. In an exemplary embodiment, a response time can be determined based on an evaluation of resource allocation and desired quality of service.

Turning next to FIG. 12, one computer implemented method 650 for controlling the universal broadcast system of FIG. 11 will now be described. In an initial step 652, the method 650 teaches providing a first channel server suitable for the transmission of digital broadcast data via a first channel. The first channel server may be coupled together with a data merger device such as described above with reference to FIG. 7, or may be a stand alone device.

In a next step 654, the method 650 teaches providing a second channel server suitable for the transmission of data-on-demand via a second channel. The second channel includes memory and processing power sufficient to be prepared off-line for later real-time data transmission. Accordingly, in a step 656, the method teaches preparing, prior to data broadcast, the second channel server for real-time transmission of data-on-demand information. This information may be VOD information, video game information, etc. One suitable method for preparing a channel server for on-demand data broadcast is described below in more detail with reference to FIG. 13.

In a next step 658, the method 650 teaches preparing and transmitting an EPG including information indicating the nature of data transmitted within the first and second channels. In particular, the EPG will indicate that the first channel contains digital broadcast data, while the second channel contains on-demand data. In a final step 660, the method 650 teaches combining and transmitting data from said first channel and said second channel.

As will be appreciated, the method 650 can readily be expanded to provide a plurality of digital broadcast and data-on-demand channels, as well as other digital information. Further, the EPG can provide a wide variety of information to the client such as programming information, commercials, etc.

With reference to FIG. 13, a computer implemented method 656 for preparing a channel server for real-time transmission of data-on-demand information will now be described. In a first step 670, the channel server receives and stores a delivery matrix providing a sequence for the real-time delivery of one or more data files in a non client specific uni-directional manner. In a next step 672, the channel server retrieves the files indicated by the delivery matrix from a persistent storage mechanism. This retrieval of digital data and the scheduling of transmission of the digital data is performed “off-line” to fully prepare each channel server for real-time data transmission. In a final step 674, the channel server informs the central controlling server that it is ready to begin transmission, at which point the central controlling server can control the digital broadcast system to begin DOD transmission.

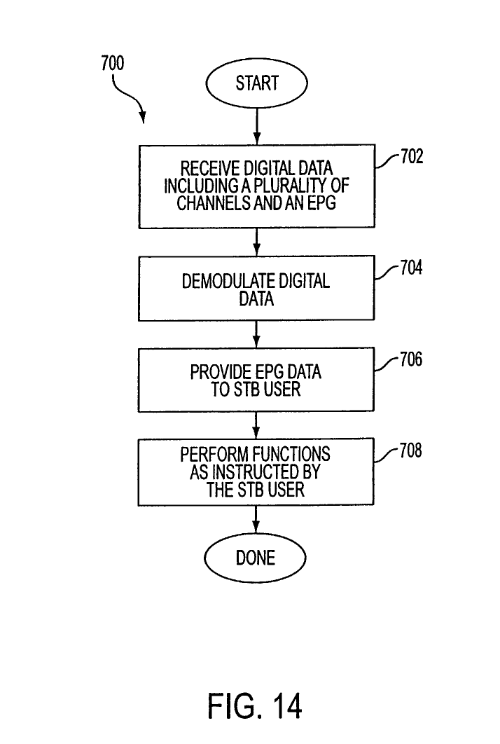

Turning next to FIG. 14, a computer implemented method 700 for controlling a universal set-top-box (STB) in accordance with one embodiment of the present invention will now be described. In an initial step 702, the method 700 teaches receiving digital data including a plurality of channels and an electronic program guide (EPG). This digital data may be received via a cable modem or other suitable communication device. The EPG provides information indicating the nature of data transmitted in each of the channels. The data in these channels can take any suitable form such as digital broadcast information or data-on-demand information.

In a next step 706, the method 700 teaches providing EPG data to a user of the universal STB. The step 706 enables the user to select through an interface device desired content from the plurality of channels. In a step 708, the method 700 teaches receiving and implementing instructions from the user of the universal STB. This may include tuning into data from multiple channels, e.g., order to view data from a first channel and record data from another channel, and performing digital video functions such as fast forward, rewind, pause, etc.

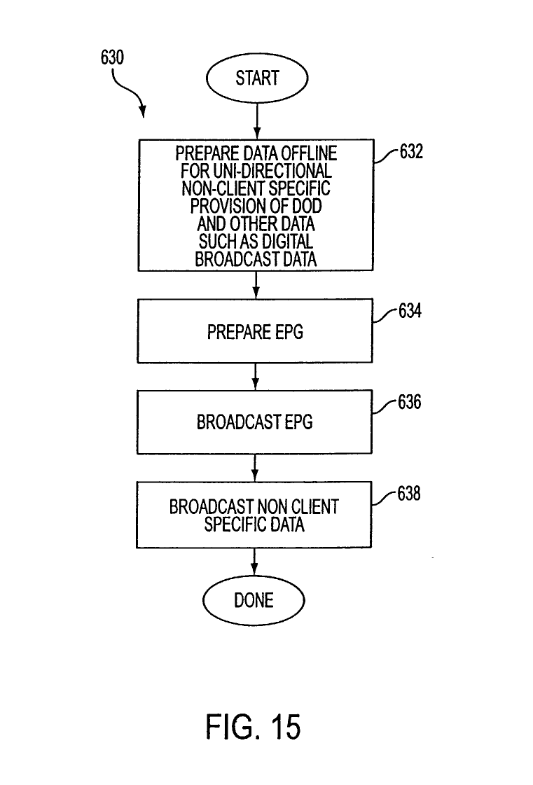

The methods of FIGS. 12-14 will now be recast in a more general manner with reference to FIGS. 15-17.

Turning first to FIG. 15, a computer implemented universal broadcast method 630 for providing non client specific data to a plurality of DOD clients will now be described. The method 630 may provide of variety of digital broadcast data, on-demand data such as VOD and games, standard cable television, and others.

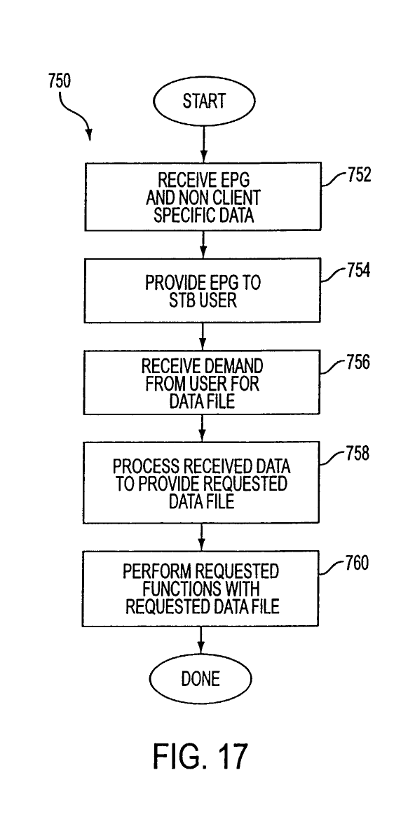

In a first step 632, the broadcast server prepares data offline for non client specific provision of DOD, digital broadcast, and other data. In the particular case of DOD, this may involve generating broadcast matrices, organizing data files by blocks, etc., as well as preparing the DOD channel servers for real-time broadcast. More detailed discussion is found below with reference to FIGS. 17 and 18, as well as in Khoi Hoang's pair of patent applications incorporated above with reference to FIG. 12.

In a step 634, the broadcast server prepares an EPG indicating the nature of the content available to universal clients. The preferred EPG will include the data type, e.g., digital broadcast or DOD, as well as an indication of the content, and program times for non on-demand data. In steps 636 and 638, the broadcast server will broadcast the prepared EPG and then the non client specific data to all clients.

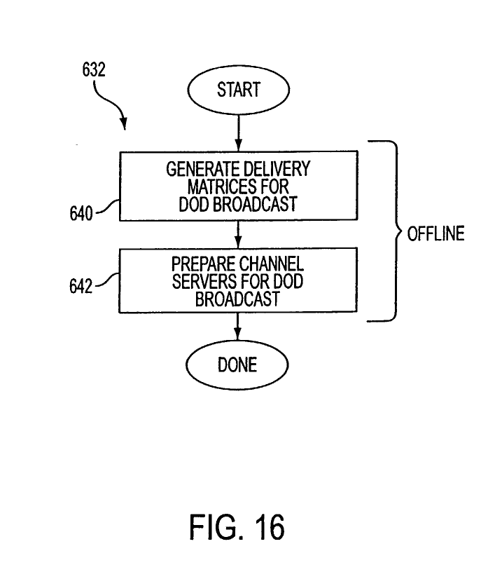

Turning next to FIG. 16, a DOD server method for preparing data off line for non client specific provision of DOD, digital broadcast, and other data suitable for accomplishing step 632 of FIG. 15 will now be described. In a first step 640, the DOD server generates delivery matrices for non client specific DOD broadcast of a plurality of data files. Preferred embodiments for generating delivery matrices are described in more detail in Khoi Hoang's pair of patent applications incorporated above with reference to FIG. 12. In a next step 642, the DOD server prepares all DOD channel servers for non client specific DOD data broadcast. This process is described above in more detail with reference to FIG. 13. Once the channel servers are prepared, the DOD server is ready to broadcast digital data.

With reference to FIG. 17, a computer implemented method 750 for controlling a universal set-top-box (STB) in accordance with one embodiment of the present invention will now be described. In a first step 752, the universal STB receives digital data including an EPG and non client specific on-demand data. The EPG indicates the nature of the received digital data and the non client specific on-demand data includes at least one data file such a video program. In a step 754, the STB provides the EPG data to a user of the universal STB. In a step 756, the STB receives a demand to perform a certain function with the at least one data file. Then in a step 758, the STB processes the non client specific on-demand data in order to perform the requested function. In a last step 760, the STB performs the requested function for the user of the universal STB.

Turning now to FIG. 18, a computer implemented method 800 for generating a constant bandwidth scheduling matrix will now be described. In Khoi Hoang's patent application Ser. No. 09/584,832, a method for generating a non client specific scheduling matrix is described. The invention of Ser. No. 09/584,832 teaches how to generate a scheduling matrix for transmitting a data file arranged as data blocks, the data blocks broadcast in a sequence which enables any client to access the data file at any moment in an on-demand data format. The method 800 of FIG. 18 teaches how to generate a constant bandwidth scheduling matrix utilizing the scheduling sequence taught by the invention of Ser. No. 09/584,832.

In a first step 802 of the method 800, a scheduling matrix is generated for a data file M represented by a fixed number of data blocks. The scheduling matrix provides a sequence for transmitting certain data blocks in a fixed time slot in order to provide non client specific on-demand data. In a next step 804, the scheduling matrix is re-interpreted as a scheduling sequence without regard to transmission time slots. In a step 806, a desired constant bandwidth utilization K is determined, where K is a constant number of data blocks to be transmitted during each transmission time slot. In a step 808, for each time slot, the next K data blocks are selected for transmission. The selection of K data blocks performed in step 808 is repeatedly cycled through the scheduling sequence in order to form a constant bandwidth scheduling matrix.

The foregoing examples illustrate certain exemplary embodiments of the invention from which other embodiments, variations, and modifications will be apparent to those skilled in the art. The invention should therefore not be limited to the particular embodiments discussed above, but rather is defined by the following claims.

1. A computer implemented universal data broadcast method comprising the act of preparing a delivery matrix defining a data transmission sequence suitable for broadcast, to a plurality of clients, on-demand data in a non client specific manner, whereby transmission of said on-demand data file requires an amount of transmission bandwidth that is independent of the number of said plurality of clients.

2. A computer implemented universal data broadcast method as recited in claim 1 further comprising the act of preparing an electronic program guide (EPG) suitable for broadcast to said plurality of clients.
